(19) United States
(12) Patent Application Publication
(10) Pub. No.: US 2003/0035300 A1
(43) Pub. Date: Feb. 20, 2003

(54) Theft resistant lamp bracket

(76) Inventor: Cary D. Branstetter, Brookville, IN (US)

Correspondence Address: Charles P. Schmal, Woodard, Emhardt, Naughton, Moriarty and McNett, Bank One Center/Tower, 111 Monument Circle, Suite 3700, Indianapolis, IN, 46204-5137, US

(21) Appl. No.: 09/933,233

(22) Filed: Aug. 20, 2001

(51) Int. Cl. F21V 7/04

(52) U.S. Cl. 362/549; 362/376; 362/545

(57) ABSTRACT

A theft resistant lamp assembly for a vehicle includes a lamp unit and a mounting bracket. The mounting bracket supports the lamp unit. An outer flange extends from the mounting bracket and an inner flange extends inwardly from the mounting bracket so as to form a lens opening. The inner flange supports the lamp unit. One or more lock tabs are adapted to resiliently deform to secure the mounting bracket to the vehicle. One or more lamp unit legs are adapted to resiliently deform to secure the lamp unit to the mounting bracket.

### TECHNICAL FIELD OF THE INVENTION

The present invention generally relates to vehicle lamp assemblies, and more particularly, but not exclusively, concerns a theft resistant lamp bracket.

### BACKGROUND OF THE INVENTION

Vehicles, particularly trucks, utilize many replaceable lamps, such as side marker lamps that are installed to clearly mark the boundaries of the tractor-trailer at night and brake lamps. Because these lamps must be replaced on a regular basis when their lamp elements fail, typically prior art lamps are formed as an assembly with a case and lens (usually of plastic), and mount a bracket permanently affixed to the vehicle. Rotation of the lamp assembly upon the bracket in a clockwise manner serves to affix the lamp assembly to a bracket, while rotation of the lamp assembly in a counter clockwise direction allows the lamp assembly to become completely removed from the bracket.

While it is important for the lamp assembly to be removable from the bracket to allow for servicing of failed lamps, such removability also allows for relatively easy theft of the lamp assemblies. Such theft has become a greater concern with the introduction of lamp assemblies utilizing light emitting diodes (LEDs) as illumination elements, as these lamp assemblies are substantially more expensive. Not only does this expense increase the loss associated with the theft of the lamp assembly, it also presents an increased incentive for theft. Efforts to stop theft have been made, such as by riveting the lamp to the vehicle. However, this solution is not practical for all types of lamps, such as grommet mounted type lamps.

Therefore, there is a need for a vehicle lamp that is theft resistant. The present invention is directed towards meeting this need.

### SUMMARY OF THE INVENTION

A theft resistant lamp assembly for a vehicle according to one embodiment of the invention includes a lamp unit and a mounting bracket coupled to the lamp unit. The mounting bracket includes an outer flange, an inner flange, one or more lock tabs, and one or more lamp unit legs. The outer flange outwardly extends from the mounting bracket and the inner flange extends inwardly from the mounting bracket to define a lens opening. The inner flange supports the lamp unit. The lock tabs are adapted are adapted to resiliently deform to secure the mounting bracket to the vehicle. The lamp unit legs are adapted to resiliently deform to secure the lamp unit to the mounting bracket.

Another form of the present invention concerns a theft resistant mounting bracket for a lamp unit of a vehicle. The mounting bracket includes an outer flange and an inner flange. The inner flange extends inwardly from the outer flange to define a lens opening. The inner flange is adapted to support the lamp unit. The mounting bracket includes one or more lock tabs adapted to resiliently deform to secure the mounting bracket to the vehicle. The mounting bracket further includes one or more lamp unit legs adapted to resiliently deform to secure the lamp unit to the mounting bracket.

One object of the present invention is to provide an improved lamp assembly. Related objects and advantages of the present invention will be apparent from the following description, claims, and drawings.

### BRIEF DESCRIPTION OF THE DRAWINGS

FIG. 1 is a first perspective view of a mounting bracket according to one embodiment of the present invention.

FIG. 2 is a second perspective view of the FIG. 1 mounting bracket.

FIG. 3 is a top-plan view of the FIG. 1 mounting bracket.

FIG. 4 is a first side view of the FIG. 1 mounting bracket.

FIG. 5 is a second side view of the FIG. 1 mounting bracket.

FIG. 6 is a first cross-sectional view of a lamp assembly that includes the FIG. 1 mounting bracket.

FIG. 7 is a second cross-sectional view of the FIG. 6 assembly.

FIG. 8 is an enlarged cross-sectional view of a portion of the FIG. 6 assembly.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As discussed herein above, many lamps now utilize LEDs as the illumination element. Because LEDs have an expected life that is longer than that of the vehicle to which they are attached, there is no need to provide for the removability of these lamp assemblies once they are installed on the vehicle. The present invention therefore provides a lamp assembly mounting bracket that does not allow the lamp assembly to be removed from the mounting bracket after the lamp assembly has been mounted on the vehicle. This mounting bracket is adapted to secure preexisting lamp units. Such a bracket makes it difficult for a thief to steal the lamp assembly off the vehicle.

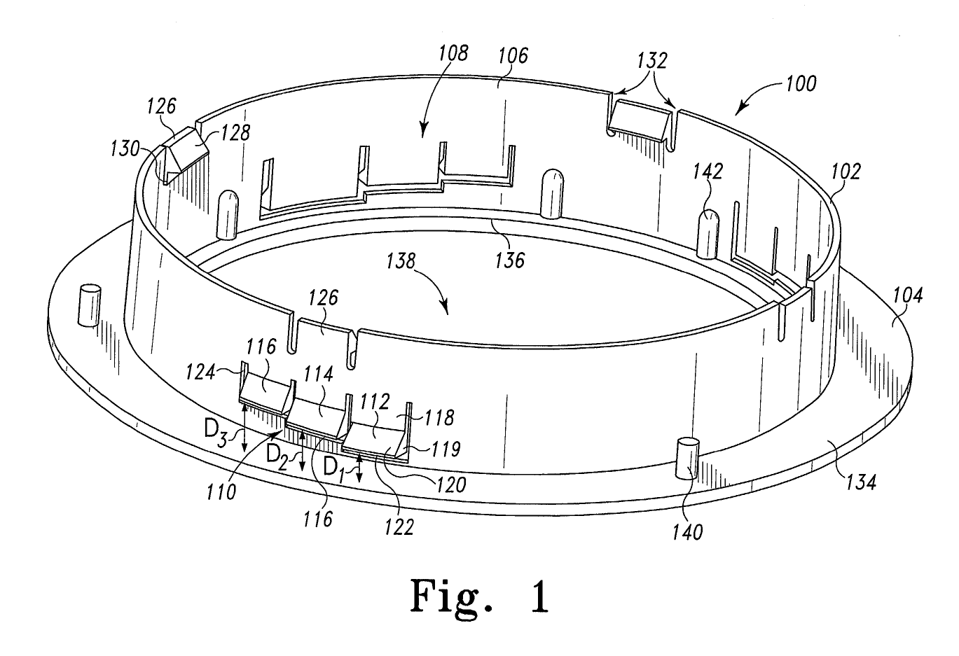

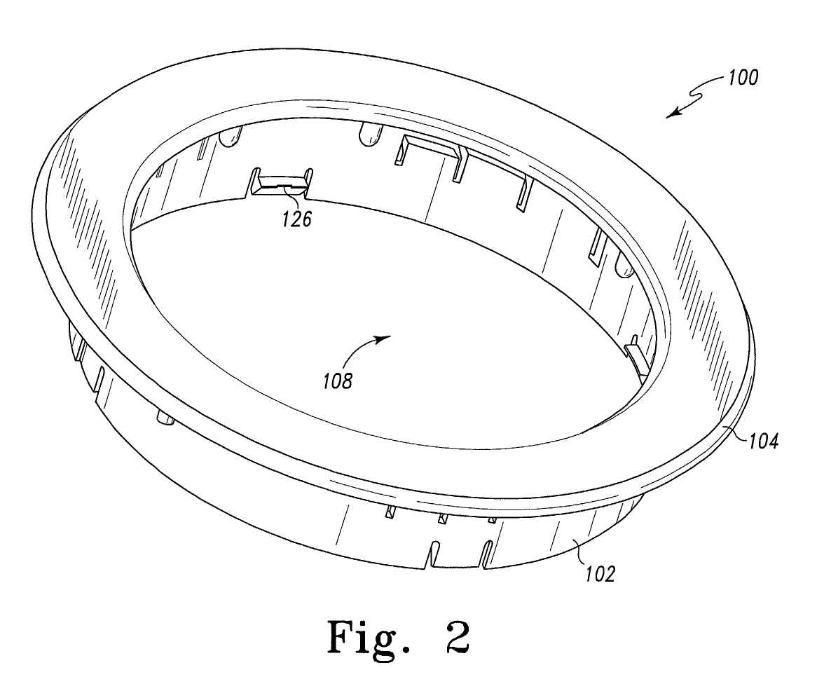

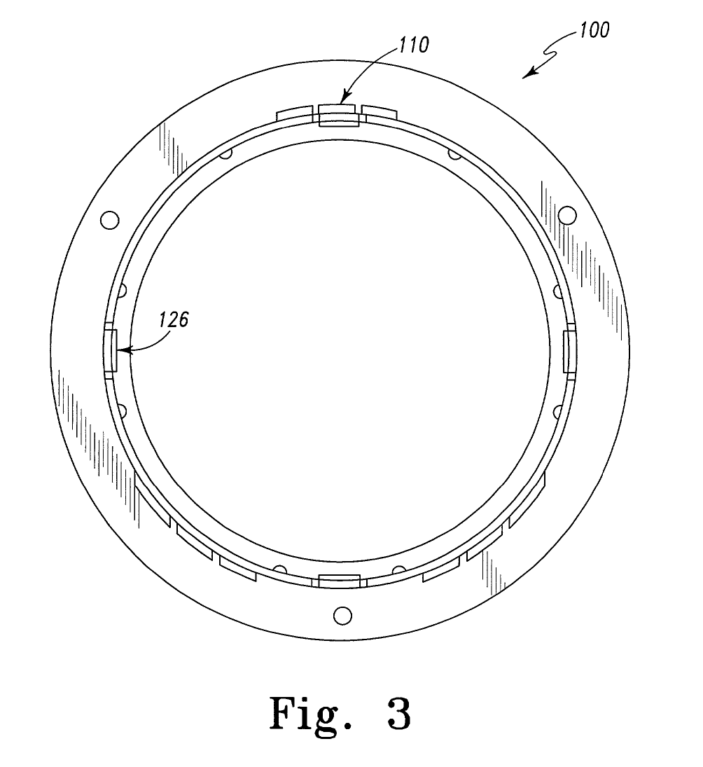

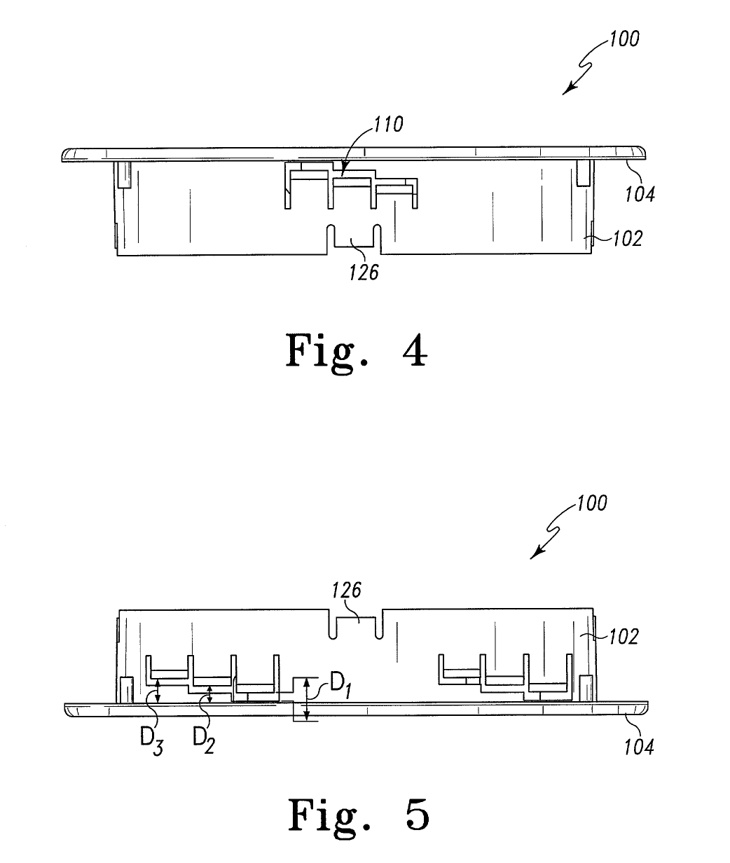

A lamp mounting bracket 100 according to one embodiment of the present invention is illustrated in FIGS. 1-5. In the illustrated embodiment, bracket 100 has a generally cylindrical shape. As should be understood, the bracket 100 can have other shapes in order to conform with differently shaped lamps. As illustrated in FIG. 1, the mounting bracket 100 includes an interior portion 102 and an exterior portion 104. When the bracket 100 is attached to a wall of the vehicle, interior portion 102 is positioned within the wall of the vehicle, and the exterior portion 104 is exposed on the vehicle. The interior portion 102 includes a generally cylindrical lock tab support member 106, which defines a lamp receiving cavity 108.

As shown in FIG. 1, the interior portion 102 further includes one or more lock tabs 110 that are resiliently attached to support member 106. In the illustrated embodiment, the mounting bracket 100 includes three sets of first 112, second 114, and third 116 lock tabs. Each lock tab 110 includes a connector member 118 that extends from the support member 106. At free end 119, which is proximal to the exterior portion 104, the connector member 118 includes an angled portion 120 that has an engaging surface 122. As illustrated, the lock tabs 110 are integrally formed within the bracket 100. The lock tabs 110 are located in a cavity 124 defined within the support member 106, and the lock tabs 110 extend toward the exterior portion 104 of the bracket 100. The angled portions 112 extend radially outward from the support member 106, and the lock tabs 110 are adapted to secure the bracket 100 to the wall of the vehicle. As should be appreciated, the mounting bracket 100 according to the present invention can include more or less lock tabs 110 than are shown.

In the illustrated embodiment, the bracket 100 further includes four lamp unit lock legs 126 that are preferably integrally formed with the bracket 100. However, it should be understood that bracket 100 according to the present invention can include more or less legs 126 than shown. Each leg 126 has an angled engagement portion 128 and connector portion 130, which connects angled portion 128 to support 106. As shown, angled portion 128 faces radially inward with respect to the support member 106. A channel 132 is defined on both sides of each leg 126 so as to allow the legs 126 to resiliently deflect.

As shown in FIG. 1, exterior portion 104 has an outer peripheral flange 134 and a radial inner flange 136. The inner flange 136 defines a lamp opening 138. Outer flange 134 includes one or more pins 140, which are adapted to prevent rotation of the bracket 100. The pins 140 are constructed and arranged to match the screw/rivet holes in a standard lamp opening. The first 112, second 114, and third 116 lock tabs each have their respective engaging surfaces 122 spaced at increasing distances D1, D2, and D3 from the outer flange 134. This allows the first 112, second 114, and third 116 lock tabs to engage walls with varying thicknesses. In the interior portion 102, one or more centering protrusions 142 extend from the inner flange 136 along the support member 106. The centering protrusions 142 provide a space for the lock tabs 110 to deflect radially inward so that the bracket 100 can be inserted into a vehicle opening.

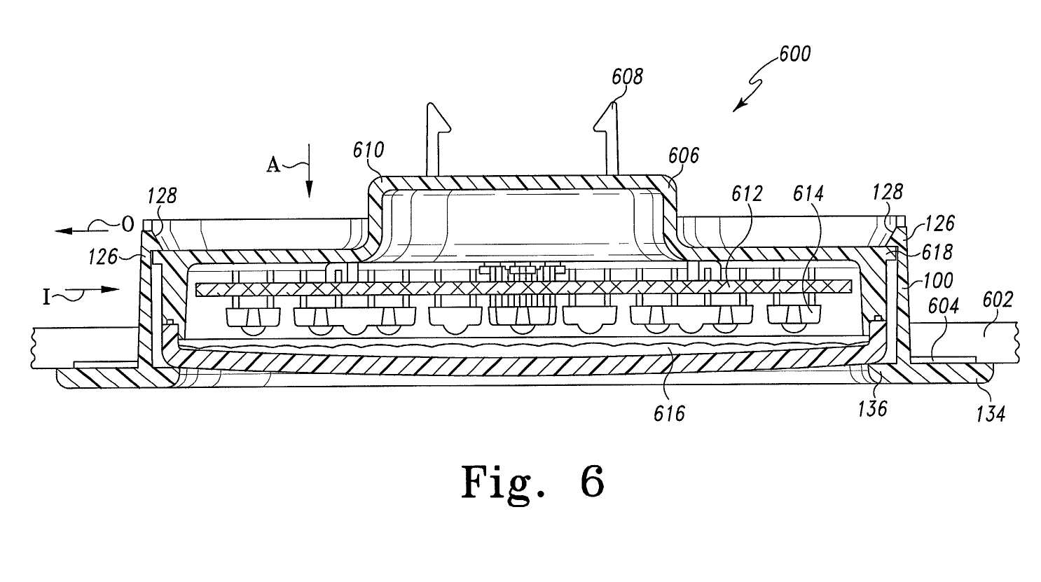

FIGS. 6-8 illustrate a lamp assembly 600 that includes bracket 100. With bracket 100, the lamp assembly 600 is attached to vehicle wall 602. A gasket 604 provides a seal between the vehicle wall 602 and the lamp assembly 600. During initial assembly of lamp assembly 600, a lamp unit 606, which is used to supply light, is inserted in direction A into cavity 108 of the flange 100. The lamp unit 606 has a harness connection member 608 and a housing 610. In the illustrated embodiment, the harness member 606 is operatively coupled to a printed circuit board 612, which has one or more LEDs 614 attached thereto. It will be appreciated that LEDs 614 may be replaced with any lighting element, such as incandescent bulbs or the like. A lens 616 encloses the LEDs 614 in the lamp unit 606. As shown, the housing 610 includes an annular lock flange 618, which engages lock legs 126. As the lamp unit 606 is pressed in direction A into the flange 100, the angled portions 128 of legs 126 cause the lock legs 126 to deflect in a radially outward direction O. Once the unit 606 passes by the angled portion 128, the flange 618 of the housing 610 engages the leg 126 by resiliently deflecting back in direction I to its original, undeflected position. Inner flange 136 engages the lens 616 such that the lamp unit 606 is secured between legs 126 and the inner flange 136. The lamp unit 606 is visible through the lamp opening 138 in the bracket 100.

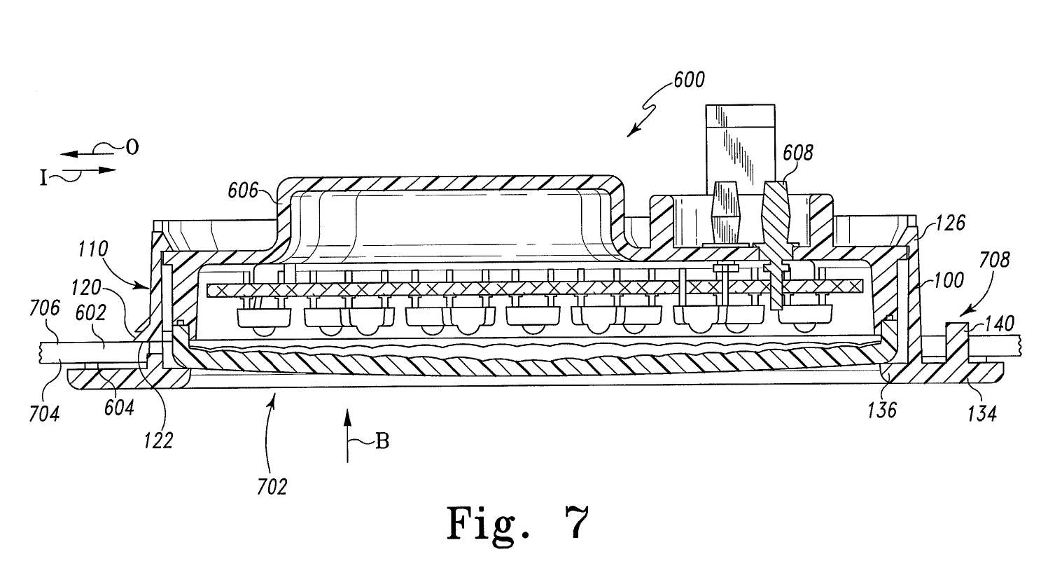

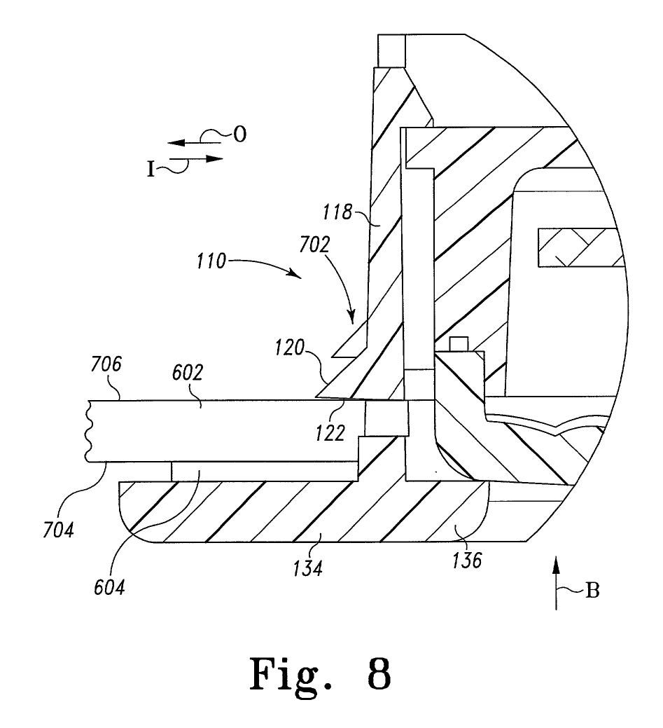

As illustrated in FIGS. 7-8, the lamp assembly 600 is inserted into a lamp opening 702 defined in vehicle wall 602. As assembly 600 is inserted in direction B into the lamp opening 702, the angled portion 120 of the lock tab 110 engages exterior surface 704 of the wall 602. As the angled surface 120 presses against the exterior surface 704, the lock tabs 110 deflect in radially inward direction I. After the assembly 600 is inserted, the lock tabs 100 resiliently return to their original undeflected positions by moving in outward direction O. Once fully inserted, the engaging surface 122 of each lock tab 100 engages interior surface 706 of the vehicle wall 602. As shown, the vehicle wall 602 along with gasket 604 is sandwiched between the outer flange 134 and the engaging surfaces 122 of the lock tabs 110. This makes removal of the lamp assembly 600 from the vehicle member 602 without damage rather difficult.

The vehicle member 602 is typically closed on the backside by a middle enclosure that is riveted to the vehicle. This makes it practically impossible for a person to remove the lamp assembly 600 without damage. The thief would have to break these rivets to access the backside of the lamp assembly 600 in order to remove the lamp assembly 600 without damage. The difficulty of this operation is likely to deter theft of the lamp assembly 600. Front-side removal of the lamp assembly 600 is likewise difficult. Several features of the lamp assembly 600 make front-side removal of the lamp 606 difficult. For example, the outer flange 134 makes it difficult for a thief to jimmy the lock tabs 110. After insertion of pin 140 into hole 708 of the vehicle member 602, the pin 140 prevents the assembly 600 from being rotated so as to remove the lamp unit 606. The staggered construction of the first 112, second 114, and third 116 lock tabs ensure that the lamp assembly 600 is tightly secured to the vehicle member 602, even if wall thicknesses vary. With the lock tabs 110 extending toward the outer flange 134, a thief is unable to disengage the lock tabs 110 by pushing them against the vehicle member 602. These features among others deter theft of the lamp unit 606.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A theft resistant lamp assembly for a vehicle, comprising:
a lamp unit adapted to provide light; and
a mounting bracket coupled to said lamp unit, wherein said mounting bracket includes
a tab support member,
an outer flange extending from said tab support member,
an inner flange extending radially inward from said outer flange and defining a lens opening for said lamp unit,
one or more lamp unit legs coupled to said mounting bracket, said legs being adapted to resiliently deform to secure said lamp unit between said legs and said inner flange, and
one or more lock tabs extending from said tab support member towards said outer flange, each of said lock tabs having a free end with a vehicle engaging surface that faces said outer flange, said lock tabs being adapted to resiliently deform to secure said mounting bracket to the vehicle.

2. The assembly of claim 1, wherein said lamp unit includes a printed circuit board, at least one light emitting diode mounted on said circuit board and a lens adapted to cover said light emitting diode.

3. The assembly of claim 1, wherein said mounting bracket includes one or more rotation prevention pins extending from said outer flange, wherein said rotation prevention pins are adapted to inhibit rotation of said mounting bracket.

4. The assembly of claim 1, wherein said inner flange has one or more centering protrusions extending therefrom, said centering protrusions being adapted to center said lamp unit.

5. The assembly of claim 4, wherein said outer flange has at least one rotation pin extending therefrom adapted to inhibit rotation of said lamp unit when secured to the vehicle.

6. The assembly of claim 1, wherein said mounting bracket has a cylindrical shape.

7. The assembly of claim 1, said lock tabs include three lock tabs each of which are adapted to engage different wall thicknesses.

8. The assembly of claim 1, further comprising a gasket provided on said outer flange adapted to seal against the vehicle.

9. The assembly of claim 1, wherein said mounting bracket is a unitary component.

10. A theft resistant mounting bracket for a lamp unit of a vehicle, comprising:
a support member;
an outer flange extending from said support member;
an inner flange extending inwardly from said outer flange to define a lens opening;
one or more lock tabs extending from said tab support member towards said outer flange, each of said lock tabs having a free end with a vehicle engaging surface that faces said outer flange, said lock tabs being adapted to resiliently deform to secure said support member to the vehicle; and
one or more lamp unit legs adapted to resiliently deform to secure the lamp unit between said lamp unit legs and said inner flange.

11. The lens of claim 10, wherein said lock tabs includes three lock tabs each of which adapted to engage different wall thicknesses.

12. The assembly of claim 10, wherein said inner flange has one or more centering protrusions extending therefrom, said centering protrusions being adapted to center said lamp unit.

13. The assembly of claim 10, wherein said outer flange has at least one rotation pin extending therefrom that is adapted to prevent rotation of said lamp unit when secured to the vehicle.

14. The assembly of claim 10, wherein said support member, said inner flange, said outer flange, said lamp unit legs, and said lock tabs are formed as a unitary component.
